(19) United States
(12) Patent Application Publication
(10) Pub. No.: US 2025/0307951 A1
(43) Pub. Date: Oct. 2, 2025

(54) Systems and methods for a cloud-based payroll processing workflow utilizing Large Language Models (LLMs)

(71) Applicant: Velocity Global, LLC, Denver, CO (US)

(72) Inventors: Srinivas Varavooru, Basking Ridge, NJ (US); Viswanathan Shivakumar, Hackensack, NJ (US)

(73) Assignee: Velocity Global, LLC, Denver, CO (US)

(21) Appl. No.: 18/810,693

(22) Filed: Aug. 21, 2024

Related U.S. Application Data
(60) Provisional application No. 63/573,084, filed on Apr. 2, 2024.

(51) Int. Cl. G06Q 40/12; G06F 40/279

(52) U.S. Cl. CPC G06Q 40/12; G06F 40/279

(57) ABSTRACT

Systems and methods for a cloud-based payroll processing workflow utilizing Large Language Models (LLMs) includes receiving a request to perform payroll for a plurality of employees associated with an employer; extracting payroll information associated with the plurality of employees; and performing one or more phases of a payroll process for each of the plurality of employees automatically via one or more trained Large Language Models (LLMs).

### CROSS-REFERENCE TO RELATED APPLICATION(S)

The present disclosure claims priority to U.S. Provisional Patent Application No. 63/573,084, filed Apr. 2, 2024, entitled “Systems and methods for a cloud-based payroll processing workflow utilizing Large Language Models (LLMs)” the contents of which are incorporated by reference in their entirety.

### TECHNICAL FIELD

The present disclosure generally relates to computer-implemented systems and methods. More particularly, the present disclosure relates to a cloud-based system for automating Human Resources (HR) practices based on one or more Large Language Models (LLMs).

### BACKGROUND

The administration of payroll is a critical and complex function within the human resources (HR) department of any organization. Traditionally, payroll processes have been characterized by manual data entry, extensive paperwork, and reliance on spreadsheets, which are time-consuming and prone to human error. These conventional methods not only increase the risk of inaccuracies in salary calculations, tax withholdings, and benefits administration but also require significant manpower and resources, leading to increased operational costs and inefficiencies. The proposed system seeks to overcome these limitations by providing a fully automated payroll system that leverages Large Language Models (LLMs). This system is designed to efficiently manage all aspects of payroll processing, from time and attendance tracking to salary calculation, tax deduction, and benefits administration, without the need for manual intervention.

### BRIEF SUMMARY

The present disclosure is directed to systems and methods for a cloud-based payroll processing workflow utilizing Large Language Models (LLMs). According to one implementation, a method includes the step of receiving a request to perform payroll for a plurality of employees associated with an employer; extracting payroll information associated with the plurality of employees; and performing one or more phases of a payroll process for each of the plurality of employees automatically via one or more trained Large Language Models (LLMs).

The steps can further include training the one or more LLMs with data specific to the one or more phases of the payroll process. The one or more LLMs can be adapted to operate with respect to a Responsible, Accountable, Consulted, and Informed (RACI) framework. Each of the one or more LLMs can be adapted to perform a specific phase of the payroll process. A non-transitory computer-readable medium for facilitating the steps can be a part of a cloud-based server configured to provide automated Human Resource (HR) services for the employer and one or more additional employers. The one or more LLMs can be adapted to monitor the one or more phases of the payroll process, and wherein the one or more LLMs are adapted to provide guidance for the payroll process. Responsive to an unexpected event occurring during the payroll process, the one or more LLMs can be adapted to provide action recommendations. The one or more LLMs can be adapted to detect whether entered information complies with any of employment policy and tax policy based on a jurisdiction of the plurality of employees.

### BRIEF DESCRIPTION OF THE DRAWINGS

The present disclosure is illustrated and described herein with reference to the various drawings. Like reference numbers are used to denote like components/steps, as appropriate. Unless otherwise noted, components depicted in the drawings are not necessarily drawn to scale.

FIG. 1 is a network diagram illustrating a cloud-based employment system for enabling the automatic execution of various Human Resources (HR) functionalities, according to one embodiment.

FIG. 2 is a block diagram illustrating the server shown in FIG. 1 for performing HR functionality, according to one embodiment.

FIG. 3 is a block diagram illustrating the employment management program shown in FIG. 2, according to one embodiment.

FIG. 4 is a diagram illustrating aspects of executing software components of the employment management program of FIG. 3, according to one embodiment.

FIG. 5 is a diagram illustrating offline processes, online processes, and version control processes associated with the employment management program of FIG. 3, according to one embodiment.

FIG. 6 is a flow diagram illustrating a method for managing employment functionality for a business, according to one embodiment.

FIG. 7 is a flow chart of a process for a cloud-based payroll processing workflow utilizing Large Language Models (LLMs).

FIG. 8 is a flow diagram of an embodiment of a LLM query orchestration architecture.

FIG. 9 is a diagram of a prompt frame.

FIG. 10 is a flow chart illustrating a process for enhanced LLM query orchestration.

### DETAILED DESCRIPTION

As mentioned, remote working scenarios (e.g., Work from Home (WFH), coworking, etc.) allow workers to work essentially anywhere in the world where Internet access is available. The present disclosure relates to systems and methods for managing the Human Resources (HR) aspects of such businesses in a way that requires less time for HR personnel and is able to automatically handle certain HR functions efficiently and effectively. In particular, the systems and methods of the present disclosure are configured to keep track of the various employment laws, rules, regulations, etc. that are applicable to different countries. Even within certain countries, a country may be divided into specific jurisdictions whereby each state, province, territory, etc. (any division or jurisdiction) within that country may also have its own set of employment rules and regulations. As an example, some jurisdictions may include employment laws in which an employer is required to provide each employee with a minimum amount of Paid Time Off (PTO), such as 20 days per year. PTO, for example, may include annual leave, sick leave, personal time off, etc. Thus, the systems and methods of the present disclosure are configured to ensure that employers (e.g., businesses, companies, organizations, enterprises, etc.) comply with the applicable laws wherever their employees are working.

Since some companies may be set up where their employees can be physically located all over the world, there may be cost advantages in some cases to having certain positions (e.g., engineers) held by people in different areas (e.g., India, Slovenia, etc.) instead of an expensive area like Silicon Valley. To support a global workforce, some big companies may have vast legal departments and establish subsidiaries in each country. For example, Big Company X may have “Big Company X India” and “Big Company X Slovenia” as subsidiaries. Also, Big Company X may be required to maintain HR, legal, compliance, etc. in each of the countries in which it operates or has employees.

Of course, maintaining a presence in different countries can be quite expensive and may require a large amount of effort and resources. Even for Big Company X, they may need to decide whether or not it would be worth it to expend their resources and efforts to “set up shop” in a given country. Therefore, one feature of the systems and methods of the present disclosure is that automated calculations can be performed to help executives and administrators to determine if it would make economic sense to enter certain new markets to leverage the local talent or if it would be better to draw from candidates within one area (e.g., Silicon Valley) and keep them centralized in that area. It is a further feature of the systems and methods to reduce and automate the effort and resources to support different countries. Furthermore, these decisions may be even more difficult for Small Company Y.

Also, as mentioned above, talent is no longer considered to be centralized in one area (e.g., within the Silicon Valley area). According to some examples, companies have found that highly qualified engineers may be dispersed throughout the world. For example, some companies have found that there may be qualified talent in software development in Eastern Europe, India, Israel, etc.

Suppose, for instance, that a small startup company has received business funding and is located in Silicon Valley, but they want to hire some remote software developers. Suppose in this example that they need a group of ten engineers and wish to pick candidates from Slovenia. In some cases, the startup may have already identified this group of engineers, but in other cases, the company may need some help to find them. If it is determined, for example, that it is too expensive or too difficult to create a Slovenian remote office, they may decide to bring this group to Silicon Valley to work with the existing employees.

Therefore, especially for smaller companies, there is a need for a cloud-based service platform that is able to perform candidate recruitment, onboarding, etc. and to perform other HR-related tasks, such as payroll and timekeeping. In this sense, a centralized server, according to the various aspects of the present disclosure, may be configured to handle much of the HR tasks automatically, thereby providing more efficient usage of resources.

Conventional systems typically require HR personnel to manually onboard new employees and perform other tasks such as payroll, timekeeping, benefits processing, etc. One issue with the conventional systems, however, is that it requires the HR staff to keep track of changes in the various employment laws throughout the world. This, of course, can be an extremely challenging task and may occasionally result in failing to adhere to certain employment laws. Typically, a company would have to engage expert resources to manage the compliance to the corresponding employment laws and regulations. Therefore, one goal of the present disclosure is to provide systems and methods that can automatically track, keep updated records of, and monitor changes to employment laws, rules, regulations, etc. throughout the world to easily allow an administrator or executive to quickly determine business costs for hiring locally or internationally. Also, the embodiments described herein allow administrators and executives to monitor where employees may be recruited from to ensure compliance with various employment laws (e.g., Paid Time Off (PTO), benefits, holidays, compliance, insurance, etc.).

### § 1.0 Cloud-Based System for Automating Human Resources (HR) Practices

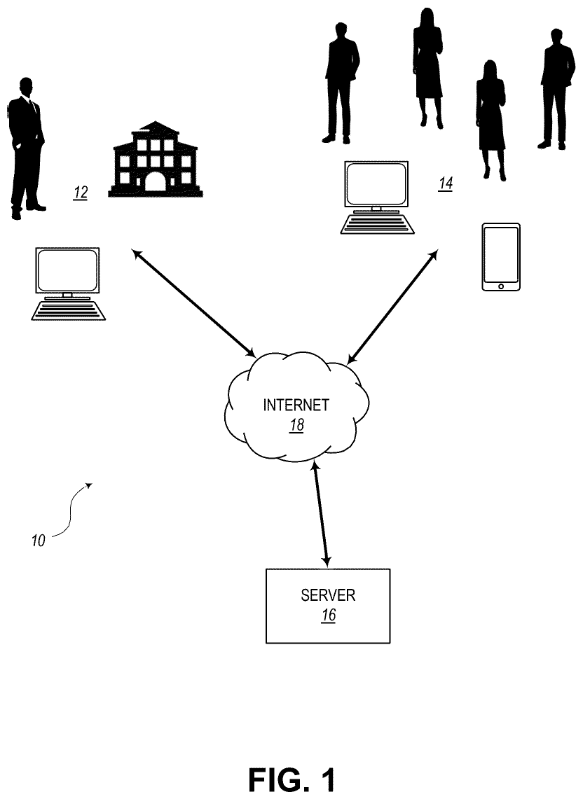

FIG. 1 is a network diagram illustrating an embodiment of a cloud-based employment system 10 for enabling the automatic execution of various HR functions with respect to one or more companies, businesses, organizations, enterprises, etc. As illustrated, the cloud-based employment system 10 generally includes a number of employers 12, a plurality of employees 14 (note, the employees 14 can be contractors, part time workers, or anyone who is paid by the employers 12 for their services), and a server 16 in communication with each other via the Internet 18, a Wide Area Network (WAN), or the like. Each employer 12 may be a company, business, or other type of enterprise, where one or more administrators (admin), managers, executives, hiring staff, etc. may perform various HR tasks for onboarding and maintaining employees 14. Although, for the sake of simplicity, a single employer 12 is shown in FIG. 1 and is described in various embodiments throughout the present disclosure, it should be noted that the server 16 may be configured to service multiple employers 12, each having its own group of employees 14.

It should also be noted that some employees 14 may be physically located at one or more centralized offices (in any country) associated with the employer 12, while some employees 14 may be located physically remote from these centralized offices (e.g., working from home, working from a public library, working from a coffee shop or coworking center, etc.). Each one of the employers 12, employees 14, and the server 16 may be associated with any suitable type of computing device (e.g., personal computer, laptop computer, tablet, mobile phone, etc.) for enabling communication through the cloud-based employment system 10 via the Internet 18. According to various implementations, many of the employment or HR duties may be automated, where little or no human interaction is needed for some of these duties.

The server 16 is configured as part of a cloud platform, system, service, etc., and enables the employers 12 and employees 14 to perform certain employment-related tasks (e.g., HR-related tasks, from onboarding, to payment and compliance, and offboarding). The cloud-based employment system 10 may include various applications (apps) on the computing device that can enable the employees 14 to enter their personal information (e.g., residence address, bank accounts, etc.). Also, the employers 12 may wish to create a job description to define aspects of one or more jobs that may be needed, some of which may include requests for employees 14 in different countries. By entering employee candidate information, the employers 12 can either identify known people who can handle certain jobs, for which there is an opening, or can provide a request that the server 16 can be used to find one or more candidates that meet the entered criteria. For example, the employer 12 might enter information pertaining to pay, title, duties, etc. The cloud-based employment system 10 can automate the entire HR process from onboarding a new employee 14, to paying the employee 14, to managing the relationship between the employee 14 and the employer 12 (e.g., PTO, hours worked, benefits, etc.), to offboarding.

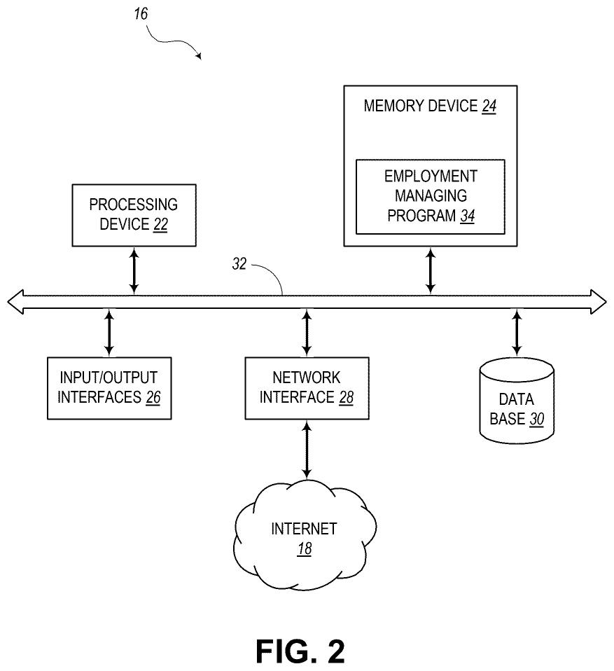

FIG. 2 is a block diagram illustrating an embodiment of the server 16 shown in FIG. 1 for performing HR functionality. In the illustrated embodiment, the server 16 may be a digital computing device that generally includes a processing device 22, a memory device 24, Input/Output (I/O) interfaces 26, a network interface 28, and a database 30. It should be appreciated that FIG. 2 depicts the server 16 in a simplified manner, where some embodiments may include additional components and suitably configured processing logic to support known or conventional operating features. The components (i.e., 22, 24, 26, 28, 30) may be communicatively coupled via a local interface 32. The local interface 32 may include, for example, one or more buses or other wired or wireless connections. The local interface 32 may also include controllers, buffers, caches, drivers, repeaters, receivers, among other elements, to enable communication. Further, the local interface 32 may include address, control, and/or data connections to enable appropriate communications among the components 22, 24, 26, 28, 30.

It will be appreciated that some embodiments described herein may include or utilize one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field-Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the embodiments described herein, a corresponding device in hardware and optionally with software, firmware, and a combination thereof can be referred to as “circuitry configured to,” “logic configured to,” etc. perform a set of operations, steps, methods, processes, algorithms, functions, techniques, etc. on digital and/or analog signals as described herein for the various embodiments.

Moreover, some embodiments may include a non-transitory computer-readable medium having instructions stored thereon for programming a computer, server, appliance, device, at least one processor, circuit/circuitry, etc. to perform functions as described and claimed herein. Examples of such non-transitory computer-readable medium include, but are not limited to, a hard disk, an optical storage device, a magnetic storage device, a Read-Only Memory (ROM), a Programmable ROM (PROM), an Erasable PROM (EPROM), an Electrically EPROM (EEPROM), Flash memory, and the like. When stored in the non-transitory computer-readable medium, software can include instructions executable by one or more processors (e.g., any type of programmable circuitry or logic) that, in response to such execution, cause the one or more processors to perform a set of operations, steps, methods, processes, algorithms, functions, techniques, etc. as described herein for the various embodiments.

Furthermore, the server 16 also includes an employment managing program 34, which may be implemented in any suitable combination of hardware, software, firmware, etc. For example, in some embodiments, the employment managing program 34, as shown, may be incorporated in non-transitory computer-readable media (e.g., the memory device 24) and may include logical code or instructions for enabling the processing device 22 to perform various functions associated with the management of employment-type aspects, such as HR-type processes.

The cloud-based employment system 10 can utilize one or more servers 16 and can be a private cloud, a public cloud, a combination of a private cloud and a public cloud (hybrid cloud), or the like. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase “Software as a Service” (SaaS) is sometimes used to describe application programs offered through cloud computing. A common shorthand for a provided cloud computing service (or even an aggregation of all existing cloud services) is “the cloud.” The cloud-based employment system 10 is illustrated herein as an example embodiment of a cloud-based system, and other implementations are also contemplated to implement the various techniques described herein.

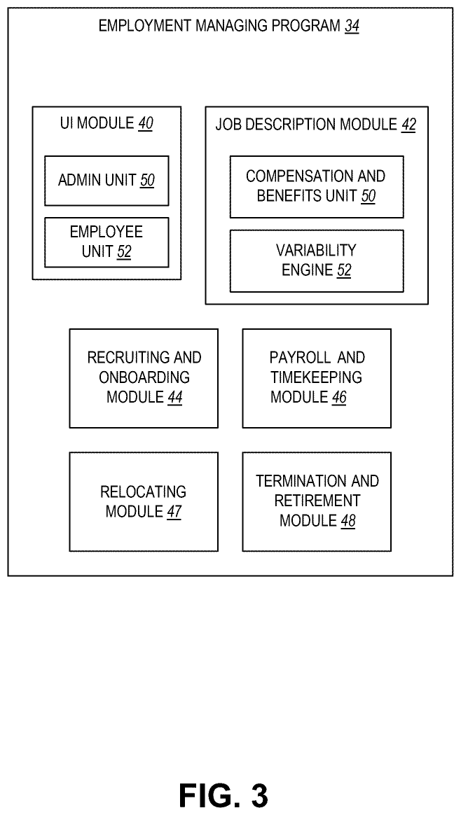

FIG. 3 is a block diagram illustrating an embodiment of the employment managing program 34 shown in FIG. 2. As shown in this embodiment, the employment managing program 34 includes a User Interface (UI) module 40, a job description module 42, a recruiting and onboarding module 44, a payroll and timekeeping module 46, a relocating module 47, and a termination and retirement module 48. The UI module 40 further includes an admin unit 50 for allowing an administrator to interface with the employment managing program 34 and an employee unit 52 for allowing an employee (or a job candidate) to interface with the employment managing program 34. Furthermore, the job description module 42 includes a compensation and benefits unit 54 and a variability engine 56. The various modules can be implemented as methods having steps, via the server 16 or the cloud-based employment system 10 configured to execute the steps, and as non-transitory computer-readable medium storing instructions for programming one or more processors to implement the steps.

The compensation and benefits unit 54 of the job description module 42 allows an administrator to enter compensation information (e.g., salary, full-time pay, part-time pay, hourly pay, profit sharing, retirement payments and matching, taxes, pay schedules, bonuses, potential for raises, etc.). This compensation information can be entered for each job that might be defined according to title, position, duties, experience, etc. The admin can also use the compensation and benefits unit 54 to enter or select benefits for each type of job. The benefits may include the amount of Paid Time Off (PTO) hours or days that may be offered to the employees, such as annual leave, sick leave, personal time off, etc. Benefits may also include holidays or other special days off. Benefits may also include various insurance offerings, such as health/medical insurance, disability insurance, workers compensation, life insurance, dental/vision insurance, etc. Benefits may also include the possibility of union representation and/or membership in certain societies, organizations, charities, etc.

The variability engine 56 may be implemented in a way to encode local employment laws so that the workflow may be substantially the same for all available countries (e.g., the 185 or so countries throughout the world where remote employees may reside and where Internet access may be available). The variability engine 56 may be configured in communication with governmental or employment websites or databases throughout the world for downloading the laws, rules, regulations, etc. regarding various employment policies. The variability engine 56 can also track changes that are made to each website or database to keep an updated record (e.g., in database 30) of each country's policies and/or the policies of various jurisdictions (e.g., states, provinces, territories, etc.) within each country. Thus, the variability engine 56 can be encoded with the applicable laws and rules throughout the world and/or have direct access to this information via a suitable database (e.g., database 30).

That is, the variability engine 56 is configured to work hand-in-hand with the compensation and benefits unit 54 to ensure that the compensation information and benefits information entered for each job associated with each jurisdiction is compliant with the relevant laws and regulations within those jurisdictions. The variability engine 56 may be configured to block the user (e.g., admin) from entering a benefits package that does not completely comply with the laws of a certain country in which a candidate (or employee) will eventually be working. For example, if the user (admin) attempts to enter PTO information giving an engineering candidate 15 days off per year, while the laws in the relevant country require that employers give at least 20 days, then either the variability engine 56 will not allow this amount to be entered and/or may provide an alert telling the user that the amount does not comply with the relevant laws.

The laws, rules, regulations, etc. (“rules”) may be encoded in the variability engine 56 using any suitable data format or language (e.g., YAML, JavaScript Object Notation (JSON), S3 buckets, etc.). YAML is a human-readable data-serialization language. It is commonly used for configuration files and in applications where data is being stored or transmitted. JSON is an open standard file format and data interchange format that uses human-readable text to store and transmit data objects consisting of attribute-value pairs and arrays. It is a common data format with diverse uses in electronic data interchange, including that of web applications with servers. S3 Buckets are public cloud storage containers for objects stored in simple storage service (S3). S3 buckets can be likened to file folders and object storage. That is, the laws, rules, regulations, etc. for each country, state, province, region, city, or any other governmental entity, as well as policies, rules, etc. for a given employer 12 can be encoded in a data format or language.

In some embodiments, the variability engine 56 may use a suitable type of version control feature (e.g., Git, GitHub, etc.) for detecting changes in the laws, rules, code, etc. Although Git is normally applicable to software development version control monitoring, the variability engine 56 can use version control (or Git) in the same or similar manner to control (or monitor) the versions of the local employment laws. Git is a distributed version control system that tracks changes in any set of computer files, usually used for coordinating work among programmers who are collaboratively developing source code during software development. Its goals include speed, data integrity, and support for distributed, non-linear workflows. The present disclosure contemplates the unique combination of using a suitable data format for encoding the rules and the version control feature for managing changes thereto.

Rules may include capturing some information from a person, verifying that information, offering that person some benefits, collecting tax for and/or from that person, paying insurance, offering time off, offering holidays, etc. That is, the rules can be a) data captured from the company, employee, or both, b) data validation of any captured data (e.g., from any database, datastore, etc.), and/or c) actions-pay the employee every two weeks, deduct taxes, pay insurance, give time off, etc. Rules can also be in the following data format: a) Defined structure, b) Interpreted at runtime, and c) Version control (Git). One goal may be for full automation from initial contact to payday through termination. Thus, the systems and methods of the present disclosure may include a cloud platform where there is no need to have someone do much of the typical HR work, such as fully automating the onboarding and payroll tasks.

The admin unit 50 of the UI module 40 may include a collection of UIs that allow an administrator, executive, hiring staff, or other person to enter information (e.g., address, phone numbers, etc.) about the business. The job description module 42 is configured to allow the admin to enter information about one or more jobs that need to be filled or have been filled. For example, the compensation and benefits unit 54 may be configured to allow the entry of compensation for each of the jobs and benefits (e.g., PTO, holidays, insurance, allowances, etc.) for each job. The variability engine 56 may also be configured to compare the enter compensation and benefits information to determine if the selected amounts comply with local laws. Also, the information retrieved by the variability engine 56 may also be used to provide options for the admin, such as an option to select a minimum amount of PTO based on the law, the minimum amount plus 5 days, the minimum amount plus ten days, etc.

The employee unit 52 of the UI module 40 may include a collection of UIs that allow a job candidate to enter information about himself or herself. Also, if the candidate is hired, this information can be saved and used for the same person who will then be identified as an employee. The candidate, new hire, or employee can use the employee unit 52 to enter and/or change personal information, such as residence address, bank account information (e.g., for automatic deposits), etc. as needed. Also, the employee can select various choices regarding insurance using the UI module 40.

In some embodiments, the employment managing program 34 also includes functionality to help with recruiting and onboarding. For example, the recruiting and onboarding module 44 may be configured to determine a specific business employment need and create a job description (e.g., title, position, salary, benefits, etc.) automatically based on the need. The recruiting and onboarding module 44 may also be configured to assist with seeking out new employees and/or advertising for job openings. Also, the recruiting and onboarding module 44 can automatically assist with scheduling interviews with candidates, narrowing down a list of candidates, and determining the most qualified candidates based on certain criteria. The recruiting and onboarding module 44 can also provide an offer letter to one or more selected candidates, receive replies regarding offer letters, and determine start times when the new employees may start. When a candidate is hired, the recruiting and onboarding module 44 can instruct new employees and offer assistance with onboarding processes to ensure the relevant benefits are properly enacted, the employee information is correct, manager information is entered, etc.

Also, the payroll and timekeeping module 46 may be configured to pay employees (e.g., using autopay or other methods) according to the compensation entered with respect to the compensation and benefits unit 54. Also, payments can be made based on a predetermined schedule and may include taking out taxes, Social Security, Medicare, etc. for each employee. Payroll tasks may also include invoicing functions. Also, timekeeping functions may include detecting hours worked (e.g., for an hourly employee), checking attendance, determining PTO used, determining bonuses and overtime hours, recording billable hours, etc.

The relocating module 47 is configured to monitor the physical location of each employee, particularly where the employee goes to perform their work duties. In some cases, an employee may live in one state (or country) while working (e.g., in an office, in a coworking space, etc.) in another state. If an employee relocates to another country, state, province, territory, etc., the relocating module 47 can assist (along with the variability engine 56) to ensure that the employee's compensation and benefits remain compliant with the local laws and make changes to the employee's contract if changes are needed. The relocating module 47 may also assist with immigration laws, international labor laws, passport processing, via processing, work visas, business visas, employment visas, etc. to ensure compliance in all aspects of employment and HR policies.

The termination and retirement module 48 may be configured for assistance with employees who are terminated or who are retiring from the company. This process may include determining severance pay, unemployment benefits, pensions, etc. and/or may include conducting tasks related to retirement accounts. The termination and retirement module 48 may also be configured to automatically change payroll information as needed and update employee information (e.g., new residence information).

The employment managing program 34 can be implemented on the server 16 shown in FIG. 1. In particular, the employment managing program 34 can include a number of layers for enabling the management of various employment functions, such as HR functions. For example, as shown, the employment managing program 34 can include an infrastructure layer, a shared capabilities layer, an analytics layer, a business capabilities layer, an Application Programming Interface (API) layer, and a presentation layer. As described below, the employment managing program 34 includes a combination of API and User Interface (UI) features that may be configured to service both employer representatives (e.g., administration personnel (admin), executives, hiring personnel, etc.) as well as employees.

The employment managing program 34 can include a GUI dashboard. The layers in the employment managing program 34 toward the top may be configured to change faster than layers toward the bottom. A unified, governed API may be created through the API layer. The layers below this can expose their APIs through the API layer. The employment managing program 34 may be developed with an API-first scenario. Every domain may own an unambiguous set of API endpoints that it may implement. Every domain may also publish events about their domain and other domains and may consume events relevant to them.

The presentation layer near the top is what is generally considered as a software product that may be installed on the server 16 and that the employers 12 (and employees 14) may use. Some of these (e.g., employment PTO time, attendance, immigration, expenses, benefits, etc.) may belong to workforce management. The light green color is part of financial management and data. There are also sales and support. A couple items are shown with dotted lines because the target state may allow UIs to be modeled accordingly.

includes visual elements (UIs) and how the employers 12 and employees 14 may interact with it (APIs). Thus, the platform may be the API layer and everything underneath it.

Information that is captured for each candidate may then be used (or reused) for another candidate or some draft form may be used as a template. The employment managing program 34 may be configured with mock offer draft that can be used for recruiting and onboarding. The offer draft may be relatively straightforward since the back end may have offers as a first class entity and an API for it.

Layers towards the top tend to change faster than the layers towards the bottom. Like at the very bottom infrastructure layer (paved road), one would expect the paved road to be established and as long as a user is on the paved road, it doesn't have to change much. Every layer that is below the API layer may expose their interfaces through the API. Each of these boxes can be thought of as having two doors-a front door and a back door, where the front door is the API.

The employment managing program 34 can allow a user to interact with the particular domain. Each domain will also publish events of things that it deems important and everybody else can consume it. For example, when a new employee is added and the onboarding is complete, the next step may be to set up their first payroll. Employment (HR) may publish a message that a new employee has been onboarded. However, employment does not have to know that the admin needs to set a payroll, but payroll would know that every new employee needs to get a new payroll.

Rather than keep polling API endpoints to see if something new has changed, the information may be entirely encapsulated within that domain. One of the advantages of this is that if something changes in employment, admin will not have to go change several other things or even know how payroll works. As long as employment says the API is the same and the published are the same, the admin can change everything underneath that, and it doesn't matter. Also, the employment managing program 34 can serve this capability through CXP or through one of a new API (or new services) in the back end, as long as the API is the same and the events are the same.

This gives autonomy, speed, and velocity to the team that owns the domain and also lines up with code owners. API First and the front end in the case of SSA may be independent of the back end because the contract may already be agreed upon. Another advantage is that API now becomes a first class citizen in the overall equation and exists as part of an HR ecosystem. This can be integrated with the rest of the ecosystem, and it may expose exactly how the domain is modeled in the real world.

Every domain may have an unambiguous API endpoint for simple implementation and every domain can then publish. LNR architectures may be work in progress. Each one of the boxes can have additional details underneath it and the user can drill it down up to the point where they have a catalog of services and endpoints that every domain implements. It can also include a catalog of all of the events that are published. And so that's why this is called a Level 0 architecture. This represents the highest level of technology available.

The solutions to various challenges with implementing the API and UI modules are described here. A first challenge was documenting API, which can be solved by using Stoplight to document the APIs and allows the use of documents the way that they may be intended to look like, how requests should look, and may also include UIs for those requests for the front end to use. The UIs may be built out from the screens shown herein. The APIs are developed with capabilities alongside the UIs, allowing them to be used and delivered on a rapid timeline.

A second issue is related to persistence of data. The systems and methods of the present disclosure are able to combine UI and API technologies, which can respect the confidentiality of some of the data that is stored. Also, as described below, the systems and methods are able to balance this with an easy to use user experience as well. For example, the employment managing program 34 may be configured to resume even if a browser has been closed or if a computer has shut off without issue. This may be applicable to a combination of browser memory and also API storage. This may be a front end and back end pairing that really can make a powerful teaming.

And lastly, reusing API calls may be a challenge that is solved by the embodiments described herein. This solution may include using a library called React Query, which may be part of the front end RFC. Through the first three challenges, it may be beneficial to parallelize the work. This allows the design of the front end and back end to work in parallel. In some embodiment, it may be possible to swap mocked data from Stoplight with real APIs once the back end has been developed. The ability to work in parallel and have a quick turnaround time can be beneficial to come back together and combine everything.

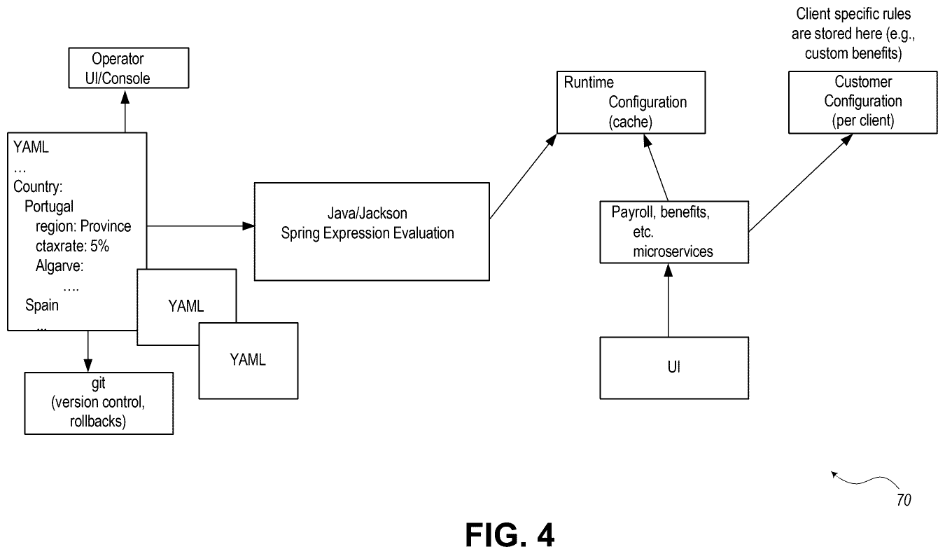

FIG. 4 is a diagram illustrating an embodiment of a software system 70 having aspects related to executing various software components of the employment management program 34. In some embodiments, a business may support myriad payroll, tax, and benefits rules in all the applicable countries (e.g., 185 countries where many companies may allow remote workers) in addition to the US. In addition, admin of some companies may choose to define their own rules for benefits, such as, for example, to provide a more generous number of days off than the minimum requirement.

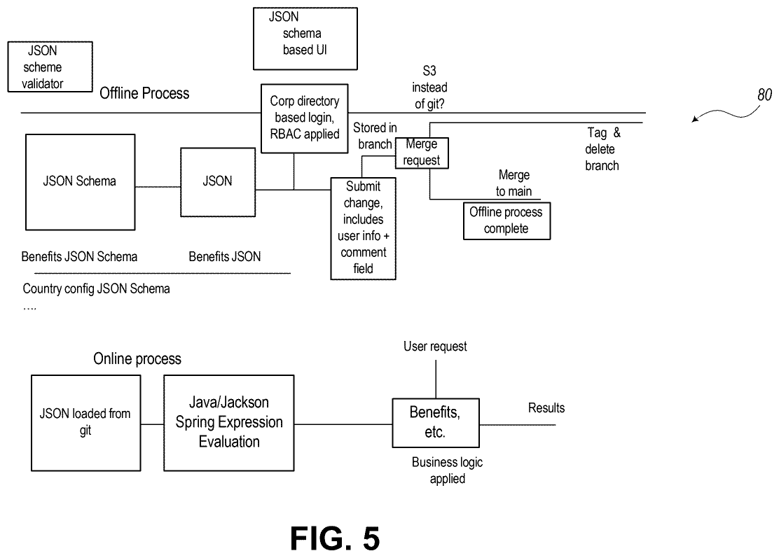

FIG. 5 is a diagram illustrating an embodiment of a system 80 having offline processes, online processes, and version control processes associated with the employment management program 34. According to some embodiments, rules may be captured in a YAML file or S3 bucket. Operators (e.g., admin, HR personnel, etc.) can change the rules using a UI built on top of the YAML file. The YAML file may be stored in Git, which may allow version control of the data and rollbacks. All changes, for example, may be in a Git audit log. A JSON Schema may be used to ensure the data is correct, and the loaded data may be validated against the schema using libraries like djv. The YAML file may be converted to runtime configuration, which may be served up by a configuration microservice. Expressions (e.g., “Algarve has country tax rate+1%”) are evaluated using spring expression evaluation. Jackson, Java parser, NodeJS parser, etc. may be used to create a runtime config, which may be stored in cache.

A company's specific rules may be stored in domain specific microservices. For example, if a client wants to give five additional holidays, this may be stored in client specific data in the benefits microservice. When a client/employee logs in, they may be presented with UIs that specialize based on the runtime configuration in cache plus the client specific rules stored in the microservices.

Runtime configuration changes do not necessarily need engineering involvement. In some cases, no code release may be required. Operators can change the config. With proper oversight, testing, and process, release updated configurations can be made to production without engineers being involved (e.g., with a robust Continuous Integration and Continuous Delivery (CI/CD) testing cycle). Configurations can be rolled back with support from DevOps. Also, for audit trails and approvals, every change may need to be approved before the change makes it to production (e.g., based on a specific approval chain) and may vary by service/config. Each change can have a complete log regarding why a change is being made.

Thus, in some embodiments, it may be possible to reduce the efforts of software engineers from the path of country specific configurations. If done correctly, this may be done instead by operations experts, product experts, domain experts, etc. and may not require software engineers to oversee operations. In some cases, there may be no releases for a change in config. The cache may get rebuilt automatically (e.g., with rules defined) when the config is updated. The Git check-in may trigger the CI/CD rules resulting in a new cache construction. Regarding audits and traceability, the user may know who has changed what and when. Also, the systems and methods may provide simplicity, such as in the case where it may be possible use off-the-shelf tooling (e.g., Git, Jackson, standard caching, JSON, etc.).

The variability engine 52 may deliver an infrastructure as defined herein. It is not necessary that the variability engine 52 knows anything about the business domain itself or how the configurations may be defined. The Business domain (e.g., benefits) may be a user of the infrastructure. The admin may know the configuration modeled in the YAML file, read the configuration data from the cache, and then apply it to the business domain. The admin may be unaware of the YAML file, the UI modules, or the Git versioning. FIG. 5 shows the workflow and the demarcation of responsibilities.

The YAML file may be meant for generic (non-client specific) data. The YAML file may be meant to be used only by the operator (e.g., a product manager, an in-country specialist, etc.). They may not know about the client specific configurations, and they should not be able to view or edit the client specific information, which may be a security issue.

Expressions can be added in YAML. YAML is a declarative language, meaning that it describes the desired state of a system or configuration, rather than providing a series of instructions for how to achieve that state (which would be an imperative approach, which may belong in a microservice). One YAML file may be stored for each capability. That is, Benefits may have a YAML file, the country config may have another, and so on. They may each be evaluated and added to separate parts of the cache. This allows independent changes and development.

### § 2.0 Cloud-Based System for Managing Employment Functionality

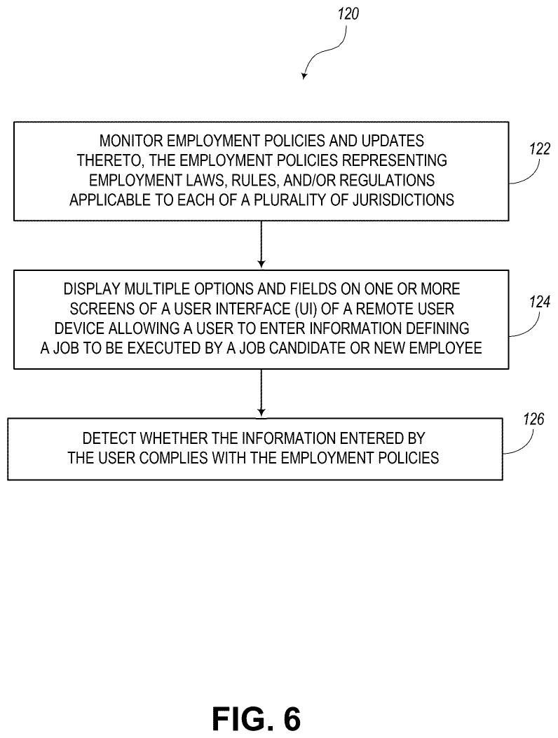

FIG. 6 is a flow diagram illustrating an embodiment of a method 120 for managing employment functionality for a business. As illustrated, the method 120 includes the step of monitoring employment policies and updates thereto, as indicated in block 122, wherein the employment policies represent employment laws, rules, and/or regulations applicable to each of a plurality of jurisdictions. The method 120 further includes the step of displaying multiple options and fields on one or more screens of a User Interface (UI) of a remote user device allowing a user to enter information defining a job to be executed by a job candidate or new employee, as indicated in block 124. Also, the method 120 includes the step of detecting whether the information entered by the user complies with the employment policies, as indicated in block 126.

The method 120 may also be executed according to various implementations. For example, the remote user device (block 124) may be associated with a company for which the job is intended to be filled. The user may be administrative, executive, or Human Resources (HR) personnel representing the company. The method 120 may be executed by a cloud-based server configured to provide automated HR services for the one or more companies or employers. The method 120 may further includes the step of displaying a quote on the UI, where the quote may be a cost for the cloud-based server to serve the company with respect to the HR services.

The step of displaying the multiple options and fields (block 124) may include the steps of a) displaying compensation options and fields and b) displaying benefits options and fields. The step of detecting whether the information entered by the user complies with the employment policies (block 126) may include a first step of detecting whether compensation information entered by the user complies with the employment policies with respect to a selected jurisdiction, where the compensation information is related to a) an annual salary, b) an hourly wage, c) equity, d) variable compensation, e) bonuses, f) allowances, g) retirement matching, and/or other elements related to compensation. The step of detecting whether the information entered by the user complies with the employment policies (block 126) may further include a second step of detecting whether benefits information entered by the user complies with the employment policies with respect to the selected jurisdiction, the benefits information related to a) Paid Time Off (PTO), b) medical/health insurance, c) life insurance, and/or other benefits.

The plurality of jurisdictions, for example, may include a plurality of countries throughout the world. Each of one or more of the plurality of countries may include one or more states, provinces, territories, cantons, divisions, regions, landers, governorates, parishes, or prefectures each having their own set of employment policies.

The method 120 may further include automatically managing one or more of a) a first set of tasks related to recruiting and onboarding new employees, b) a second set of tasks related to payroll and timekeeping, c) a third set of tasks related to employee relocation, and d) a fourth set of tasks related to termination or retirement of employees. The method 120 may also include the step of updating the first, second, third, and fourth sets of tasks based on updates to the employment policies.

In some embodiments, the method 120 may also include the step of displaying hiring guidelines on the UI, where the hiring guidelines may be related to the employment policies of one or more of the plurality of jurisdictions. The method 120 may also consider factors regarding locations of one or more job candidates with respect to one or more of a) hiring locally, b) hiring internationally, c) remote work, d) establishing a subsidiary in another jurisdiction, e) passport policies, f) immigration policies, and g) work visa policies.

According to some embodiments, the method 120 may further include a company flowchart that can include the following:
1. The company may wish to hire Candidate X in Country Y. They can enter the job description data as well as the new candidate information on the cloud platform of the server 16, the information including pay, duties, etc.
2. The company can provide Candidate X with an offer letter from the cloud platform with full compliance with laws in Country Y.
3. Then, Candidate X can go to the cloud platform and either accept or reject the offer. If accepted, Candidate X can enter his or her personal data (e.g., bank account information, residence address, etc.).
4. When Candidate X begins working for the company and becomes Employee X, Employee X may update his or her personal data as needed. The cloud platform may be configured to provide other HR services, such as making payments to Employee X and ensuring that all local laws are complied with based on the encoded rules for Country Y.

According to one example, suppose that dock workers in France have become unionized. The employment managing program 34 may be configured to enter such a rule that asks for a union number of the new employee and verify that the union number is placed in a database (e.g., database 30). This and other types of similar situations can be monitored by the variability engine 56 of the employment managing program 34 and entered into the database. The relevant information can be provided as options or fields that can be added to the various screens provided to the UI of the remote user device and/or can allow the user to select certain options to ensure that updated employment policies are adhered to.

In some cases, there may be a hierarchy of rules. For example, suppose that PTO in the UK has a minimum requirement of 20 days off. However, suppose that a local law in London requires 25 days. Suppose too that a company wishes to offer more than the minimum and includes an option for the user to select 30 days and to provide 35 days for engineers working in London. Therefore, the job title information, work location information, and specific company information can all be used to determine a minimum amount of time off for engineers working in London.

In some embodiments, when the user clicks on the option 96 to learn more about certain hiring guidelines, the employment managing program 34 may be configured to display information to instruct a hiring manager of other company representative about the relevant employment policies in a specific country (or other jurisdiction) of employment. Again, the employment policies may include the specific employment laws, rules, regulations (e.g., taxes, leave policies, termination rules, time off policies, retirement policies, etc.) in the area where the company is intending to hire from or where a current employee is intended to be transferred or relocated to. This information may help the user to enter information and conform to the applicable policies.

Furthermore, the employment managing program 34 is further configured to determine a cost associated with hiring an employee from a particular location and providing compensation and benefits to the employee. Therefore, this can be done in a trial mode without actually advertising the job opening, interviewing candidates, or providing an offer letter. Therefore, the company can see the cost of hiring such a candidate and compare the cost with hiring from one or more other locations based on other applicable employment policies. This can be used by the company to determine various costs for establishing a business presence in different countries, states, regions, territories, provinces, etc. Also, this information can be used for encouraging the hiring of employees from certain remote countries, allowing employees to work remotely in these places, etc.

### § 3.0 Payroll Process Enhancement Using LLMs and RACI Framework Integration

The present disclosure provides systems and methods for enhancing payroll processing using Large Language Models (LLMs) and integrating task responsibility frameworks. Traditionally, payroll processing is a manual process that is inherently error prone and requires the involvement of a variety of personnel. There is a need for a system to automate the payroll process which can handle notifications, unexpected events, and making decisions based on a knowledge base. In such systems, the utilization of LLMs, whether customized for a specific purpose or trained on a large dataset, can enhance decision-making and the overall process flow.

The systems and methods disclosed herein pertain to a system that integrates one or more advanced Large Language Models (LLMs) with a payroll processing workflow encompassing various stages. This system is distinguished by its utilization of various LLMs to furnish guidance on subsequent actions, leveraging its extensive knowledge base. The core of the present system lies in its strategic incorporation of a RACI (Responsible, Accountable, Consulted, Informed) framework, meticulously ensuring that all pertinent stakeholders are appropriately involved at each phase of the process. The RACI model is instrumental in delineating the roles and responsibilities of each stakeholder, thus optimizing collaboration and decision-making. The RACI model can be contemplated as follows.

Responsible: The entity or entities who do the work. They are the ones who complete the task or make the decision. There can be multiple entities responsible, but typically there's one lead.

Accountable: The entity who is ultimately accountable for the correct and thorough completion of the task. This entity approves the work that the Responsible party has done.

Consulted: These are the entities who need to give input before the work can be done and approved. They are often subject matter experts.

Informed: These entities need to be kept in the loop about task progress and outcomes. They are not directly involved in the task but need to be aware of its progress.

In various embodiments of the present disclosure, the one or more LLMs can be contemplated as performing any of the RACI responsibilities. Such cases are further described herein.

A fundamental feature of the proposed system is its capability to adeptly handle unexpected events that may arise during the workflow. This adaptability is primarily facilitated by LLMs, which, by utilizing its vast repository of knowledge and being fine-tuned with payroll processing data, offers solutions to mitigate disruptions, thereby safeguarding the continuity and efficiency of the process. The integration of LLMs with the RACI framework ensures that all actions taken in response to unforeseen challenges are communicated and executed in alignment with the designated roles of stakeholders, enhancing the overall efficacy and resilience of the system.

In various embodiments, the present processes are contemplated as being facilitated through the payroll and timekeeping module 46 of the employment managing program 34 described herein. That is, the payroll and timekeeping module 46 can facilitate its functions utilizing the various LLMs while adhering to the RACI framework as described herein.

In various embodiments, a specific and customized knowledge base is created for training the various LLMs. That is, A comprehensive knowledge base is created, capturing common actions, decisions, and solutions related to various payroll stages. This knowledge base can then be used to train various LLMs for each phase of the payroll process. Further, for each stage of the payroll process, stakeholders are defined based on the RACI framework. Doing so ensures that responsibility and accountability are clear in order to reduce ambiguity. As described, the present systems can be utilized to handle unexpected events. For example, when an unexpected event occurs, such as, but not limited to, missing data, system error, etc., the event is passed to an LLM. Because the LLM is trained on a large dataset which includes access to the knowledge base, i.e., custom payroll processing data, the LLM for the given phase can suggest an appropriate action or solution. Further, stakeholders receive, from the present system, notifications based on their role in the RACI matrix. As actions are taken and decisions are made, the system updates its state, ensuring a closed-loop control mechanism.

Thus, the present system integrates one or more LLMs to provide decision-making guidance during payroll processing. The integration of the RACI framework within the payroll process allows the system to provide notifications to inform stakeholders based on their roles within the RACI matrix. The system is adapted to handle unexpected events via the LLM by providing action suggestions based on the unexpected event. For example, the system can be adapted to monitor the payroll process and provide action suggestions based on any detected events. Such detected events can include the system detecting that a data input phase of the payroll process is taking longer than expected. This can cause the system to determine that missing data may be the reason for the delay, allowing the system to make suggestions based thereon. Similarly, the system can detect an error in the payroll and timekeeping module 46 and make recommendations based thereon. For example, recommend a user to check one or more databases for missing data, provide steps for correcting a system error, and the like.

In various embodiments, a plurality of LLMs can be enabled to perform the various phases of the payroll process. That is, the manual steps of the payroll process can be performed automatically by one or more LLMs. Thus, an output of one LLM can include rules and data for a next step of the payroll process to be ingested by another LLM. A prompt for each of the one or more LLMs can include instructing the LLM to follow and conform to the RACI guidelines, and instruct the LLM to, in response to any doubt or error, consult personnel in the RACI framework. In various embodiments, in response to any doubt or error, the LLM can be adapted to consult another LLM adapted to resolve such problems.

In order for the system to automatically perform the payroll processes as described herein, the system is adapted to extract payroll information associated with the plurality of employees of an employer. That is, the payroll and timekeeping module 46 of the employment managing program 34 is adapted to fetch any data necessary to perform its intended tasks. This information/data can be stored within the server and extracted therefrom. The extracting of information can include extracting, from a database, any payroll information necessary to complete the payroll process.

Again, the various LLMs described herein can be fine tuned using specific data associated with the various phases of the payroll process. In embodiments utilizing a plurality of LLMs, each of the LLMs can be fine tuned for a specific purpose, such as for each phase of the payroll process. Thus, the various LLMs are not fundamental models, but customized models for performing specified tasks more efficiently and accurately. For example, a phase in the payroll process can include tax withholding. As described herein, different countries can have vastly different laws, rules, regulations, etc. that are applicable to taxes. Based on such data, an LLM can be fine-tuned to perform the specified payroll task of tax withholding. Because the systems and methods of the present disclosure are configured to keep track of the various employment laws, rules, regulations, etc., the LLMs can be trained with such data, thus allowing the present systems to perform such steps as tax withholding with great accuracy and efficiency.

In an example use case, the present systems can be utilized for applying a bonus to an employee's payroll with the least amount of tax burden. By providing the system, i.e., the payroll and timekeeping module 46 with the bonus information, the systems can determine the best way to apply the bonus to the employees' pay while preventing the employee from incurring unnecessary taxes. The information provided to the system can include information such as bonus amount, country of residence of the employee, etc. The systems can then proceed with the payroll process given the information provided.

Additionally, similar to the processes described above for onboarding an employee, the present systems can detect whether the information entered by a user within the payroll process complies with the employment policies of various jurisdictions based on tax laws associated with a jurisdiction of an employee. For example, when entering withholding information, the present systems can detect whether it complies with the jurisdiction of the employee for which it is being entered. Such capabilities of the present system can be contemplated as performing as the accountable party within the RACI model. That is, the LLM is accountable for the correct and thorough completion of the task and approves the work that has been done.

Because the present system automates the decision-making process and ensures clear responsibilities, the payroll process becomes much more streamlined and enhances efficiency. The one or more LLMs provide well-informed suggestions based on the payroll process knowledge base, reducing errors, and ensuring that the payroll process is accurate. Further, by having the ability to handle unexpected events that would traditionally introduce delays and reduce efficiency, the present system ensures that the payroll process is not unduly disrupted.

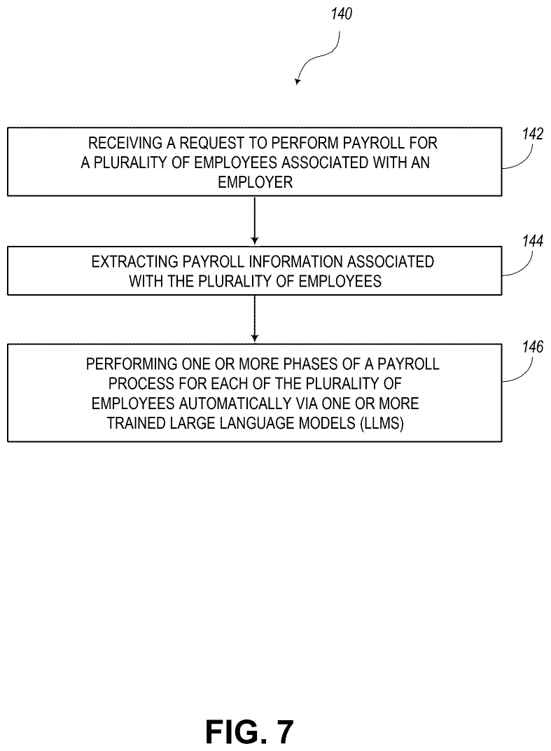

FIG. 7 is a flow chart illustrating a method 140 for a cloud-based payroll processing workflow utilizing Large Language Models (LLMs). The method 140 includes receiving a request to perform payroll for a plurality of employees associated with an employer (step 142); extracting payroll information associated with the plurality of employees (step 144); and performing one or more phases of a payroll process for each of the plurality of employees automatically via one or more trained Large Language Models (LLMs) (step 146).

The method 140 can further include training the one or more LLMs with data specific to the one or more phases of the payroll process. The one or more LLMs can be adapted to operate with respect to a Responsible, Accountable, Consulted, and Informed (RACI) framework. Each of the one or more LLMs can be adapted to perform a specific phase of the payroll process. A non-transitory computer-readable medium for facilitating the steps can be a part of a cloud-based server configured to provide automated Human Resource (HR) services for the employer and one or more additional employers. The one or more LLMs can be adapted to monitor the one or more phases of the payroll process, and wherein the one or more LLMs are adapted to provide guidance for the payroll process. Responsive to an unexpected event occurring during the payroll process, the one or more LLMs can be adapted to provide action recommendations. The one or more LLMs can be adapted to detect whether entered information complies with any of employment policy and tax policy based on a jurisdiction of the plurality of employees.

### § 4.0 Enhanced LLM Query Orchestration

The present disclosure further pertains to the field of natural language processing. That is, various embodiments further utilize systems and methods for orchestrating query processing across distributed LLMs and rest endpoints encapsulating compartmentalized data in environments handling Personally Identifiable Information (PII). By integrating LLMs into applications associated with sensitive information, various data privacy and security challenges are introduced. Traditional methods compromise both the efficiency of the query process and the strict confidentiality required in such circumstances. Thus, a need for a framework which can balance these requirements exists. The present disclosure provides such a framework for ensuring both efficient domain-specific query processing and robust data privacy protections.

Various embodiments of the present disclosure provide an advanced orchestration framework for distributed LLM processing. The present framework is specifically designed to maintain data privacy while also efficiently handling specialized queries. Various embodiments include a structured prompt data frame for standardized query encapsulation, and a dynamic, secure orchestration mechanism for data access across a plurality of system components. The present systems can be utilized in coordination with the HR systems described herein. That is, the LLM query orchestration described herein can be utilized to query data that can potentially contain PII such as sensitive and personal employee information. This can be implemented in coordination with the payroll processing enhancements such as when sensitive information is required.

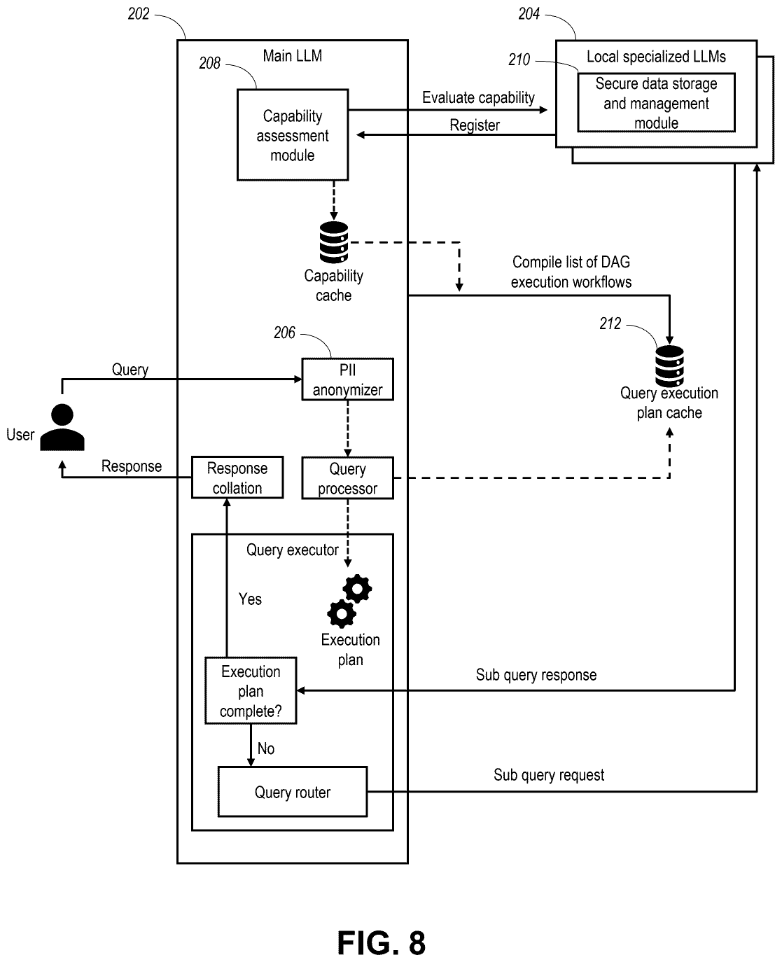

FIG. 8 is a flow diagram of an embodiment of the present LLM query orchestration architecture. The present architecture includes a main LLM 202 which acts as an orchestrator, one or more local LLMs 204 acting as specialists, a Pll anonymization module 206, a capability assessment module 208, an access control manager, and a secure data storage and management module 210. The main LLM 202 is central to the system and receives queries, conducts initial data sanitization, and dynamically generates optimal routing plans based on query content and system capabilities. The local LLMs 204 include queryable rest endpoints encapsulating secure and compartmentalized data and specialized processors with domain specific knowledge, ensuring detailed and accurate responses to specialized queries. The PII anonymization module 206 safeguards privacy by deleting and anonymizing PII in queries prior to further processing. The capability assessment module 208 determines the processing capabilities and access permissions of Local LLMs 204 to inform optimal query routing. The access control manager manages secure access to the system, enforcing data privacy through mechanisms such as access tokens and authorization protocols such as OAuth2 protocol. Finally, the secure data storage and management module 210 maintains the integrity and confidentiality of data at rest, employing advanced encryption techniques.

As discussed, a prompt frame can by utilized by the present systems. A prompt frame is a structured data packet designed for secure and efficient communication within a distributed LLM processing system such as the architecture described herein. All necessary information is encapsulated for the lifecycle of the query, including user inputs, processing instructions, context, and metadata. Thus, the systems are adapted to ensure accurate and privacy-compliant processing across a plurality of LLM components.

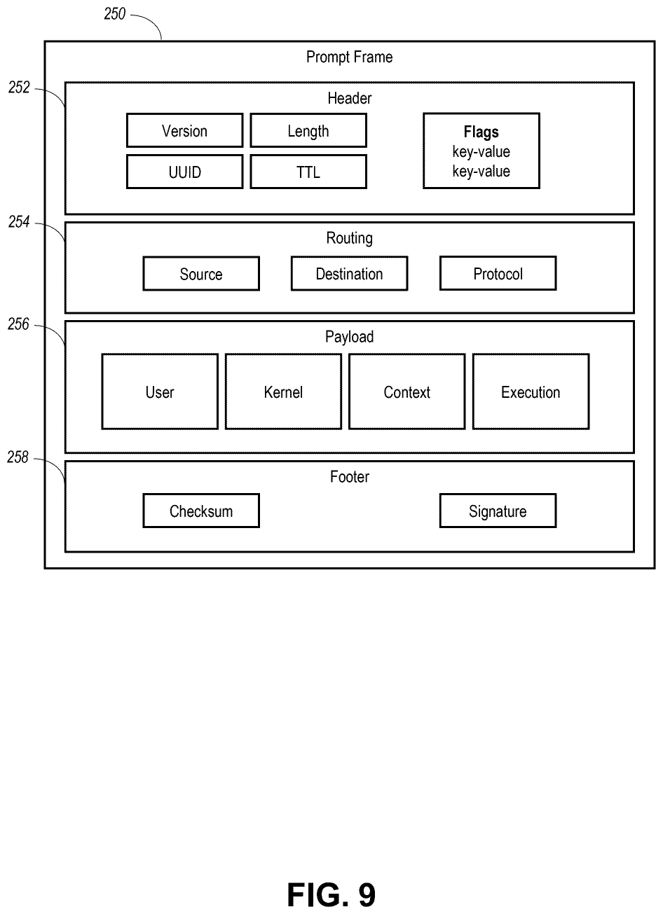

FIG. 9 is a diagram of a prompt frame. The prompt frame 250 includes a plurality of sections, each adapted to serve a specific purpose in the query process workflow. A header 252 includes essential metadata about the prompt frame 250. This metadata can include, but is not limited to, the version of the prompt frame format, the total length of the prompt frame, a unique identifier (UUID) for the prompt frame, a set of flags indicating special processing instructions such as urgency, privacy level, etc., and a Time-To-Live (TTL) limiting the lifespan of the prompt frame to prevent infinite routing loops.

A routing information section 254 includes information for guiding the prompt frame through the system. In various embodiments, the routing information section 254 includes a source address identifying the sender to ensure traceability and source verification, a destination address specifying the target LLM or system component, and a protocol defining the type of processing or query language used for aiding in proper interpretation by the recipient.

The data payload section 256 includes the core content of the prompt frame divided into further subsections. A user subsection includes the user's query and any related user context information. A kernel subsection provides processing guidelines, privacy directives, and compliance requirements to be adhered to during query processing. A context subsection provides additional context for the query such as domain hints and previous interactions that may influence the processing. An execution subsection details the planned execution workflow, including specifications for a Directed Acyclic Graph (DAG) that outlines the processing sequence and dependencies.

A footer section 258 ensures the integrity and security of the prompt frame 250. The footer section 258 includes a checksum for error detection and integrity verification as well as a digital signature or cryptographic token to authenticate the source and ensure the prompt frame 250 has not been compromised.

By utilizing the present prompt frame 250, the present systems are adapted to adhere to industry standards for data security and privacy. Such industry standards include encryption standards, data format standards, and authentication and authorization standards. The prompt frame 250 can conform to such standards by utilizing TLS for data in transit and AES for data at rest, ensuring that all information within the prompt frame 250 is securely encrypted. Further JSON is utilized for data formatting, thus providing interoperability and ease of parsing across different systems and programming languages. Again, the present systems can implement OAuth2 for managing access control to ensure that only authorized components can access or modify the prompt frame 250.

### § 4.1 Enhanced LLM Query Orchestration Workflow

In various embodiments, the present enhanced LLM query orchestration workflow includes an initial capability assessment, optimal query plan derivation and DAG execution tree creation, and security query processing and response generation. The initial capability assessment includes a dynamic or pre-executed process where the main LLM 202 assesses the capabilities and permissions of local LLMs 204 to create a secure query processing plan. The optimal query plan derivation and DAG execution tree creation includes leveraging the capability assessment represented as a DAG execution tree, dictating a secure, efficient query processing pathway. Security query processing and response generation includes processing queries according to the DAG execution plan with responses securely aggregated and returned to the requester via an interactive UI as described herein.

Again, the operational workflow of the present framework is designed to prioritize efficiency, security, and the dynamic nature of query processing in a distributed LLM system. This enhances performance by reducing query latency by incorporating advanced planning and caching strategies, such as pre-processing various capability assessments. That is, in various embodiments, the capability assessment of local LLMs is performed during initialization of the framework/systems rather than at the time of query in order to increase efficiency and security. By performing the capability and permissions assessments of the local LLMs 204 in advance, the latency can be reduced for each query. Further, by identifying each of the local LLMs 204 domain expertise and access permissions, the systems can ensure that queries are only routed to components that are authorized and capable of processing them.

By utilizing insights gained from the initial capability assessments, the main LLM 202 can perform various tasks to further optimize query processing. The main LLM 202 is adapted to analyze historical query data to identify common classes of queries and their respective domain requirements. This analysis helps the system understand the types of queries frequently processed by the system and their typical processing pathways. For each identified class of common queries, the main LLM 202 is adapted to formulate an optimal query plan. This plan can be represented as a DAG execution tree. Thus, the various pre-defined plans provide secure and efficient processing pathways tailored to the specific requirements of each query class. Further, the pre-defined query plans and their corresponding DAG execution trees are stored in a query execution plan cache 212. The caching strategy can employ the Most Frequently Used (MFU) algorithm, which prioritizes the retention of query plans that are accessed most often. This approach ensures that the system efficiently retrieves and reuses query plans for common queries, significantly improving response times.

By employing the above mentioned processes, the present systems are adapted to efficiently and securely process queries. Responsive to receiving a new query, the main LLM 202 checks the query execution plan cache 212 for any matching pre-defined query execution plans. Responsive to finding a matching plan, the cached plan is immediately utilized, thereby bypassing the need for the dynamic capability assessment and plan formulation further described herein. Alternatively, for queries that do not match a plan in the query execution plan cache 212, the main LLM 202 dynamically formulates a query-specific execution plan based on the most current capability assessment data. This process ensures that all unique queries are processed efficiently and securely. Regardless of whether a cached or dynamically generated execution plan is used, queries are processed according to the designated DAG execution pathway associated with each of the dynamically generated or cached query execution plans. Responses from local LLMs 204 are securely aggregated by the main LLM 202 and returned to the requester, adhering to all specified privacy and security protocols.

The main LLM 202 can be contemplated as an intelligent routing hub which does not have access to any private or sensitive data. Its primary purpose is to analyze structure and domain requirements of incoming queries and, based on the pre-initialized understanding of the capabilities and specializations of local LLMs 204, route these queries accordingly for processing based on formulated query execution plans. As stated, the main LLM 202 is designed to operate without needing to access private data contained within queries. This design ensures that sensitive information remains within the secure confines of the corporate network, such as within the local LLMs 204, significantly reducing the risk of data breaches or unauthorized access. In order to further increase privacy, all queries passed through the main LLM 202 are anonymized and/or redacted to remove PII or other sensitive information.

As described, the local LLMs 204 reside within the secure perimeter of a corporate network. These local LLMs 204 are granted access to private data necessary for processing their assigned queries. The access provided to these local LLMs 204 is continuously controlled and subject to rigorous authentication and authorization protocols to prevent misuse. By utilizing various local LLMs 204 which are trained with and have access to specialized data, the local LLMs 204 can process queries relevant to their domain specialization. This ensures informed and accurate decision-making without requiring the sharing of sensitive information with the main LLM 202. Local LLMs 204 are adapted to adhere to organizational privacy policies and security measures, ensuring that all data handling and processing activities comply with applicable laws and regulations. The system architecture supports regular audits and updates to maintain high standards of data protection.

This refined operational method significantly boosts the system's effectiveness by initializing capability assessments ahead of time, strategically implementing the MFU algorithm to cache query plans, and ensuring frequent queries are processed with minimal latency. This technique not only enhances the processing efficiency of queries but also fortifies the commitment to maintaining security and privacy, thereby rendering it exceptionally suitable for managing sensitive information, such as PPI.

Central to the present systems is the integration of advanced PII anonymization techniques, which utilize forefront algorithms for the refined detection and anonymization of PII, thus ensuring the protection of sensitive data during queries. The system further introduces a robust framework for access control and authentication, employing dynamic access tokens, the OAuth2 protocol, and Multi-Factor Authentication (MFA) to secure access to its components. A key feature of this invention is the implementation of end-to-end encryption for data in transit, guaranteeing that all data exchanges within the system are encrypted to thwart unauthorized interceptions. Additionally, the system adopts secure data storage practices by encrypting data at rest and applying stringent access controls, effectively preventing unauthorized data access. This comprehensive system not only facilitates the secure and efficient querying of data but also sets a new standard for data privacy and security in information technology.

Although the examples described herein describe the system as especially tailored for Human Resources (HR) applications, its versatile architecture makes it widely applicable across various fields that manage sensitive data, including healthcare, financial services, and legal industries. The present LLM query orchestration framework represents a notable leap forward in the realm of natural language processing, particularly for applications dealing with PII. This system introduces methods for encapsulating structured data, dynamically directing queries according to an immediate evaluation of capabilities and applying rigorous security protocols. This innovation establishes a benchmark for the secure and effective handling of specific queries across distributed LLM ecosystems.

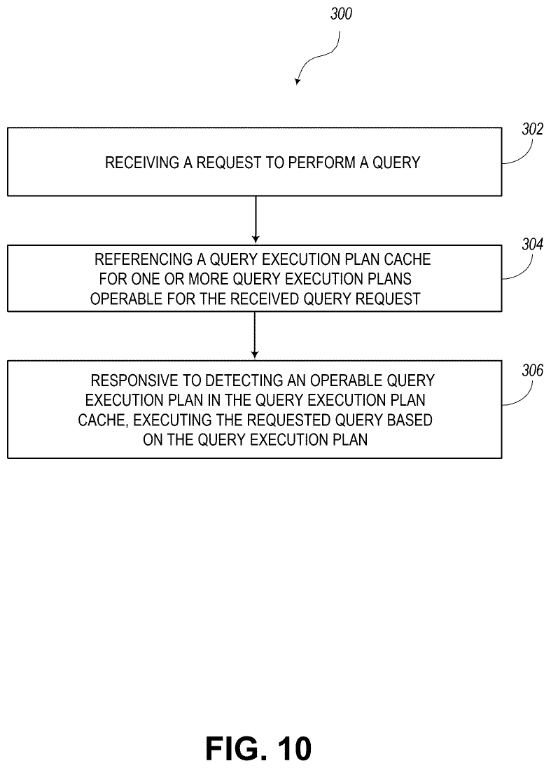

FIG. 10 is a flow chart illustrating a process 300 for enhanced LLM query orchestration. The process 300 includes receiving a request to perform a query (step 302); referencing a query execution plan cache for one or more query execution plans operable for the received query request (step 304); and responsive to detecting an operable query execution plan in the query execution plan cache, executing the requested query based on the query execution plan (step 306).

The process 300 can further include wherein the receiving and referencing are performed by a main Large Language Model (LLM), and the executing is performed by one or more local LLMs. The request to perform a query can include Personally Identifiable Information (PII), wherein the further include anonymizing the Pll such that the main LLM does not have access to PII. The one or more local LLMs are located within a secure perimeter of a corporate network. Prior to the receiving, the steps can include performing, via the main LLM, a plurality of capability assessments of each of the one or more local LLMs; formulating a plurality of query execution plans based on the plurality of capability assessments; and storing the plurality of query execution plans in the query execution plan cache. The storing can include storing the plurality of query execution plans in the query execution plan cache based on a Most Frequently Used (MFU) algorithm. The steps can further include responsive to not detecting an operable query plan in the query execution plan cache, performing a dynamic capability assessment; formulating a query execution plan based on the dynamic capability assessment; and executing the requested query based on the formulated query execution plan.

### § 5.0 Conclusion

Although the present disclosure has been illustrated and described herein with reference to various embodiments and examples, it will be readily apparent to those of ordinary skill in the art that other embodiments and examples may perform similar functions, achieve like results, and/or provide other advantages. Modifications, additions, or omissions may be made to the systems, apparatuses, and methods described herein without departing from the spirit and scope of the present disclosure. All equivalent or alternative embodiments that fall within the spirit and scope of the present disclosure are contemplated thereby and are intended to be covered by the following claims.

What is claimed is:

1. A non-transitory computer-readable medium having instructions enabling a processor to perform steps of:
receiving a request to perform payroll for a plurality of employees associated with an employer;
extracting payroll information associated with the plurality of employees; and
performing one or more phases of a payroll process for each of the plurality of employees automatically via one or more trained Large Language Models (LLMs).

2. The non-transitory computer-readable medium of claim 1, wherein prior to the receiving, the steps comprise:
training the one or more LLMs with data specific to the one or more phases of the payroll process.

3. The non-transitory computer-readable medium of claim 1, wherein the one or more LLMs are adapted to operate with respect to a Responsible, Accountable, Consulted, and Informed (RACI) framework.

4. The non-transitory computer-readable medium of claim 1, wherein each of the one or more LLMs are adapted to perform a specific phase of the payroll process.

5. The non-transitory computer-readable medium of claim 1, wherein the non-transitory computer-readable medium is part of a cloud-based server configured to provide automated Human Resource (HR) services for the employer and one or more additional employers.

6. The non-transitory computer-readable medium of claim 1, wherein the one or more LLMs are adapted to monitor the one or more phases of the payroll process, and wherein the one or more LLMs are adapted to provide guidance for the payroll process.

7. The non-transitory computer-readable medium of claim 6, wherein responsive to an unexpected event occurring during the payroll process, the one or more LLMs are adapted to provide action recommendations.

8. The non-transitory computer-readable medium of claim 6, wherein the one or more LLMs are adapted to detect whether entered information complies with any of employment policy and tax policy based on a jurisdiction of the plurality of employees.

9. A cloud-based server comprising:
a processing device; and
a memory device configured to store a computer program having instructions that, when executed, enable the processing device to perform steps of
receiving a request to perform payroll for a plurality of employees associated with an employer;
extracting payroll information associated with the plurality of employees; and
performing one or more phases of a payroll process for each of the plurality of employees automatically via one or more trained Large Language Models (LLMs).

10. The cloud-based server of claim 9, wherein the steps comprise:
training the one or more LLMs with data specific to the one or more phases of the payroll process.

11. The cloud-based server of claim 9, wherein the one or more LLMs are adapted to operate with respect to a Responsible, Accountable, Consulted, and Informed (RACI) framework.

12. The cloud-based server of claim 9, wherein each of the one or more LLMs are adapted to perform a specific phase of the payroll process.

13. The cloud-based server of claim 9, wherein the one or more LLMs are adapted to monitor the one or more phases of the payroll process, and wherein the one or more LLMs are adapted to provide guidance for the payroll process.

14. The cloud-based server of claim 13, wherein responsive to an unexpected event occurring during the payroll process, the one or more LLMs are adapted to provide action recommendations.

15. The cloud-based server of claim 13, wherein the one or more LLMs are adapted to detect whether entered information complies with any of employment policy and tax policy based on a jurisdiction of the plurality of employees.

16. A method comprising steps of:
receiving a request to perform payroll for a plurality of employees associated with an employer;
extracting payroll information associated with the plurality of employees; and
performing one or more phases of a payroll process for each of the plurality of employees automatically via one or more trained Large Language Models (LLMs).

17. The method of claim 16, wherein prior to the receiving, the steps comprise:
training the one or more LLMs with data specific to the one or more phases of the payroll process.

18. The method of claim 16, wherein each of the one or more LLMs are adapted to perform a specific phase of the payroll process.

19. The method of claim 16, wherein the one or more LLMs are adapted to monitor the one or more phases of the payroll process, and wherein the one or more LLMs are adapted to provide guidance for the payroll process.

20. The method of claim 19, wherein the one or more LLMs are adapted to detect whether entered information complies with any of employment policy and tax policy based on a jurisdiction of the plurality of employees.
